(19) United States
(12) Patent Application Publication
(10) Pub. No.: US 2023/0217898 A1
(43) Pub. Date: Jul. 13, 2023

(54) Pet Mind Toy

(71) Applicants: Gina Nash, Cherry Hill, NJ (US); Fred Nash, Cherry Hill, NJ (US)

(72) Inventors: Gina Nash, Cherry Hill, NJ (US); Fred Nash, Cherry Hill, NJ (US)

(21) Appl. No.: 17/647,597

(22) Filed: Jan. 10, 2022

(51) Int. Cl. A01K 15/02; A01K 5/01

(52) U.S. Cl. CPC A01K 15/025; A01K 5/0114

(57) ABSTRACT

A pet mind toy comprising a plurality of sides detachably coupled to each other via a plurality of edges. A first side includes at least four slots carved into the first side for holding treats for a pet, and at least four doors for the least four slots. A second side comprises a plurality of levels with each level having a slide inclined with respect to each level from a first end towards a second end. A plurality of openings is integrated at the second end of each slide to connect the plurality of levels. A third side having a rod coupled with a popsicle over a tray. A fourth side having a pull toy affixed to the fourth side for the pet to play tug with the pull toy. The plurality of sides engages the pet in mind stimulating activities for a time duration without intervention.

### FIELD OF THE DISCLOSURE

The present disclosure relates to a pet mind toy. More particularly, the invention relates to a pet mind toy which is a multi-activity cube designed for pets that provides the pet mind stimulation without the need for human involvement.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different apparatuses and devices related to entertaining pets, wherein such apparatuses and devices themselves may also correspond to implementations of the embodiments of the disclosed subject matter and claimed invention.

Domestic animals especially pets rely on their owners as a source of companionship and entertainment. However, many owners often have busy daily schedules that restrict the amount of time that an owner can commit to entertaining a pet. As such, owners often rely on pet toys or pet entertainment devices such as balls, string, or the like. Such pet toys generally allow the pet to entertain themselves by chasing and/or grabbing at the toy. To gain the pets attention, the toys often move either under their own power or by momentum imparted from the pet and/or owner.

For example, a feline may bat at a ball and cause the ball to roll. The movement of the ball further engages the attention of the feline and causes the feline to continue to chase and bat at the ball. A review of the prior art indicates that pet toys have been in use for decades. Typically, pet toys, including dog toys, cat toys, and other pet toys, are comprised of materials such as rubber, plush fabric, TPE (thermoplastic elastomer), and/or the like, or even edible materials. Pet toys may be in the form of a bone, animal, or other forms, many perceived to be recognizable by the animal—e.g., a mouse in the case of cats, a squirrel in the case of dogs. Further, some pet toys may be of solid construction or they be hollow. While these devices may be suitable for the particular purpose to which they were intended, they are not suitable as a mind stimulating puzzle toy that animals can play with in a way that engages them in learning behaviors and rewards them while learning.

Prior art, for various aspects contained there within, relevant to this disclosure, includes U.S. Pat. No. 10,772,298B1 to Alan, U.S. Pat. No. 7,320,296B2 to Morrison, U. S. Pat. Publication No. 20100077961A1 to Lipscomb, and U.S. Pat. Publication No. 20210127637A1 to Citak. In each of these prior art references, an animal entertainment device is provided to entertain pets. However, the prior art does not disclose a solution to the problem of stimulating a pet's mind and/or otherwise providing unattended entertainment to a pet without complete human intervention.

In particular, reference '298 to Alan discloses an animal-operated puzzle and treat toy, including a body that includes a storage portion defining a treat cavity and a manipulator element connected to the body. The manipulator element is adjustable relative to the body to produce an access opening to the treat cavity, wherein the cavity is large enough such that a food treat or other reward item may be released through the access opening to the environment. A plurality of different possible initial states is provided to correspond to different levels of difficulty required to make the access open. However, unlike the subject matter of the disclosed invention Alan does not disclose that a reward or treat being provided from the animal-operated puzzle structure when the pet solves the puzzle around different sides of the animal-operated puzzle structure.

Reference '296 to Morrison discloses an entertainment device for use by pets. The entertainment device can have a hollow enclosure with access openings and exit openings. The hollow enclosure may have one or more play items with diameters larger than the access openings and the exit openings within the hollow enclosure. The hollow enclosure may also have one or more smaller play items with diameters larger than the access openings and smaller than the exit openings. The smaller play items may be used external to the hollow enclosure to entertain the pet. However, unlike the subject matter of the disclosed invention, Morrison does not discuss or suggest the aspect of providing a treat to the pet through the same entertainment device. Further, Morrison does not disclose the aspect of stimulating the pet's mind using different puzzle activities.

With reference to '961 to Lipscomb therein is disclosed a pet furniture assembly comprising a pair of spaced apart and opposed sidewalls, a pair of spaced apart and opposed end walls attached to each one of the sidewalls, and a panel in communication with at least one of the sidewalls and end walls that provides a floor when the pet furniture assembly is disposed in a first position. Further disclosed is that the sidewalls extend generally upwardly relative thereto and provides a roof when the pet furniture assembly is disposed in a second position where the sidewalls extend generally downwardly relative thereto. However, unlike the subject matter of the disclosed invention, Lipscomb does not disclose or suggest the aspect of engaging the pet in different mind stimulating activities for a long duration without human intervention and providing a treat to the pet within the assembly after the completion of an activity.

Reference '637 to Citak discloses a toy for pets, in particular for dogs, comprising a housing with a floor, a lid and side walls with openings, through which, in the housing, at least one longitudinal sliding element and at least one transversal sliding element are placed in a movable manner. However, unlike the subject matter of the disclosed invention, Citak does not discuss or suggest the aspect of providing treat to the pet through the same entertainment device. Further, Citak does not disclose the aspect of stimulating the pet's mind using different puzzle activities.

Given the deficiencies of the prior arts, the need remains for an effective and entertaining mind stimulating apparatus for a pet without human intervention while also providing treats from the same apparatus when the pet solves a puzzle.

### SUMMARY OF THE DISCLOSURE

According to embodiments illustrated herein, a novel, simple and inexpensive pet mind toy is disclosed. The pet mind toy comprises a plurality of sides detachably coupled to each other via a plurality of edges. Further, the plurality of sides of the pet mind toy are interchangeable and replaceable with different panels or sides. Further, a first side of the plurality of sides comprises at least four slots carved into the first side for holding treats for a pet. Further, the first side comprises at least four doors for the at least four slots. A first door and a second door for a first slot and a second slot, respectively, are locking doors with fastening means. The first door and the second door are adjoiningly constructed together using fastening means such as a mesh of metal bars welded together. Further, a third door is a flap door for a third slot and a fourth door is a knob door for a fourth slot. Further, a second side of the plurality of sides comprises a plurality of levels with each level provided with a slide inclined with respect to each level from a first end towards a second end. Further, the second side comprises a plurality of openings integrated at the second end of each slide to connect the plurality of levels. The second side also comprises a flap opening integrated over the second side to receive a ball into the plurality of levels which moves between the plurality of levels via the plurality of openings. It is a further object of the disclosure that a ball is paced into the second side via the flap opening so that the ball is dragged by the pet towards the plurality of openings. Further, the ball may exit—e.g., come out of the second side via an outer opening integrated at a bottom level of the plurality of levels of the second side. Further, the pet mind toy comprises a third side of the plurality of sides having a rod coupled with a popsicle placed in a tray. The tray is placed to collect melted ice from the popsicle placed over the rod to minimize any mess around the pet mind toy. Further, the pet mind toy comprises a fourth side of the plurality of sides having a pull toy affixed to the fourth side for the pet to play tug with the pull toy. Further, the pet mind toy comprises a fifth side of the plurality of sides having means for providing weight to the pet mind toy, such as a liquid fill container with an opening. Further, the liquid filling opening has an embedded screw top allowing a liquid fill container to be filled with a liquid such as water so that the pet mind may be used as a pull toy. The pull toy comprises a handle with a braided rope attached to it so that the pet can play tug with it. Therefore, such as pet mind toy using the plurality of sides engages the pet in mind stimulating activities for longer durations without human intervention.

In one embodiment, a pet mind toy comprises a plurality of sides detachably coupled to each other via a plurality of edges. Furthermore, a first side of the plurality of sides comprises at least four slots carved into the first side for holding treats for a pet. Even further, the first side of the pet mind toy comprises at least four doors for the at least four slots. Yet further, the pet mind toy comprises a second side of the plurality of sides. The second side comprises a plurality of levels with each level having a slide inclined with respect to each level from a first end towards a second end which challenges the pet to move an item such as a ball, for example, against gravity to an opening configured on the slide. Further, a plurality of openings is integrated at the second end of each slide to connect the plurality of levels. Further, the second side of the pet mind toy comprises a flap opening integrated over the second side to receive a ball into the plurality of levels which moves between the plurality of levels via the plurality of openings. Further, the pet mind toy comprises a third side of the plurality of sides. Even further, the third side comprises a rod holding a popsicle (or other treat) placed in a tray. The tray is coupled transversely normal to the third side of the pet mind toy. Yet further, the rod may be provided with a spring to push the popsicle, and the tray is configured to collect melting ice from the popsicle placed over the rod to minimize mess around the pet mind toy. Further, the pet mind toy comprises a fourth side of the plurality of sides comprises a pull toy affixed to the fourth side for the pet to play tug with the pull toy. Furthermore, the pull toy comprises a handle coupled to the fourth side of the pet mind toy using a pair of straps. Even further, on a fifth side, the pet mind toy includes means for providing weight to the pet mind toy, such as the addition of metal weight plates, dumb bells, etc. In an embodiment, a liquid fill container with a liquid filling opening is provided having an embedded screw top allowing a liquid fill container to be filled with a liquid, such as water, so that the pet mind may be used as a pull toy. A braided rope is provided and is knotted to the handle for the pet to play tug with the pull toy. Therefore, in accordance with the present disclosure, such a pet mind toy facilitates the use of the plurality of sides to engage the pet in mind stimulating activities for a longer duration without human intervention.

Other features and aspects of this disclosure will be apparent from the following description and the accompanying drawings.

### BRIEF DESCRIPTION OF THE DRAWINGS

While the specification concludes with claims particularly pointing out and distinctly claiming particular embodiments of the present disclosure, various embodiments of the present disclosure can be more readily understood and appreciated from the following descriptions of various embodiments of the present disclosure when read in conjunction with the accompanying drawings, in which:

FIG. 1A illustrates an isometric view of a pet mind toy, according to an embodiment of the present disclosure;

FIG. 1B illustrates a front view of a first slot and a second slot carved on a first side of the pet mind toy, according to an embodiment of the present disclosure;

FIG. 1C illustrates a locking door of the first slot and the second slot, according to an embodiment of the present disclosure;

FIG. 1D illustrates a front view of a third slot carved on the first side of the pet mind toy, according to an embodiment of the present disclosure;

FIG. 1E illustrates a front view of a fourth slot carved on the first side of the pet mind toy, according to an embodiment of the present disclosure;

FIG. 1F illustrates a knob door of the fourth slot, according to an embodiment of the present disclosure;

FIG. 1G illustrates a side view of the knob door of the fourth slot, according to an embodiment of the present disclosure;

FIG. 2A illustrates a front view of a second side of the pet mind toy, according to another embodiment of the present disclosure;

FIG. 2B illustrates a sectional view of the second side of the pet mind toy, according to another embodiment of the present disclosure;

FIG. 3 illustrates a popsicle coupled on a third side of the pet mind toy, according to another embodiment of the present disclosure;

FIG. 4 illustrates a pull toy coupled at a fourth side of the pet mind toy, according to another embodiment of the present disclosure; and

FIG. 5 illustrates a top view of a fifth side of the pet mind toy, according to another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred systems, and methods are now described.

Embodiments of the present disclosure will be described more fully hereinafter with reference to the accompanying drawings in which like numerals represent like elements throughout the several figures, and in which example embodiments are shown. Embodiments of the present disclosure may, however, be embodied in alternative forms and should not be construed as being limited to the embodiments set forth herein. The examples set forth herein are non-limiting examples and are merely examples among other possible examples.

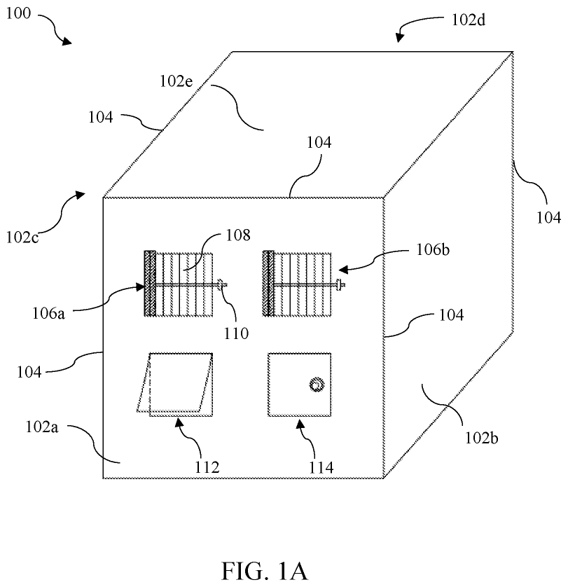

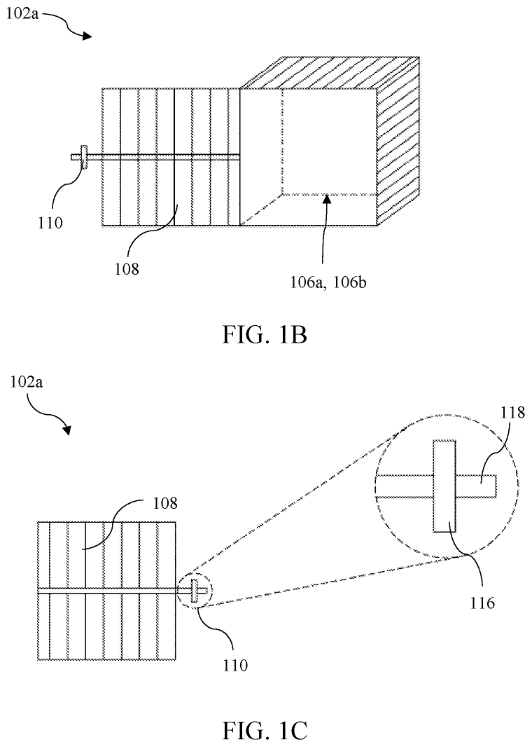

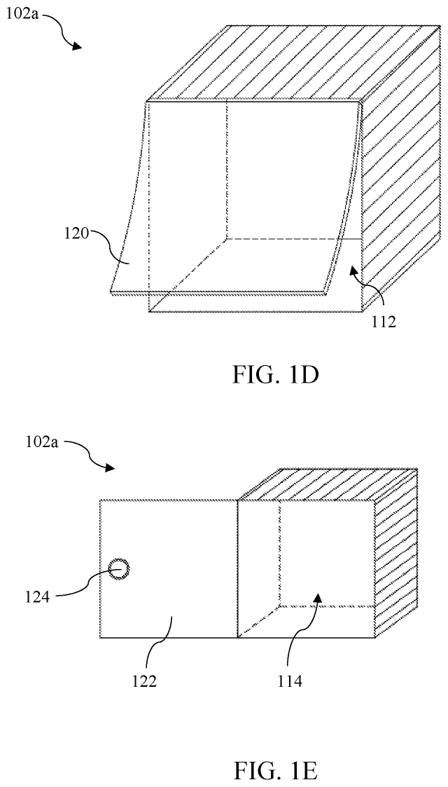

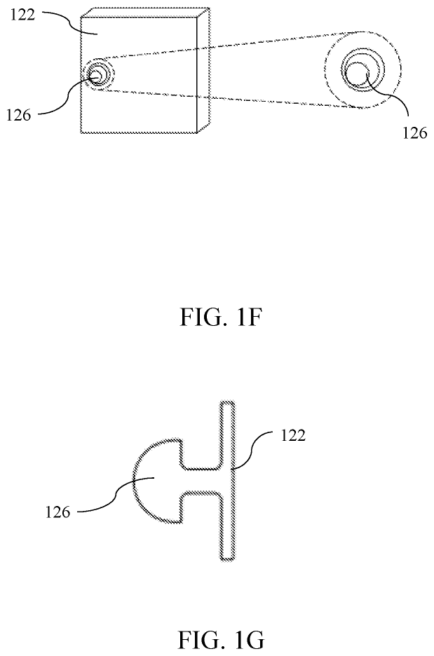

FIG. 1A illustrates an isometric view of a pet mind toy 100, according to an embodiment of the present disclosure. FIG. 1 is described in conjunction with FIGS. 1B-1G, FIGS. 2A-2B, FIG. 3, FIG. 4, and FIG. 5.

The pet mind toy 100 may comprise a plurality of sides 102 detachably coupled to each other via a plurality of edges 104. The pet mind toy 100 may also be referred as a multi-activity apparatus or mind stimulating apparatus for pets. The pet mind toy 100 may be employed for a purpose of engaging a pet for multiple hours in an activity or puzzle without human intervention. The pet mind toy 100 may also provide a plurality of activities or puzzles for the pet to perform and to earn a reward or treat after completion of the performed activity or puzzle. In this manner the pet such as a dog or cat may be engaged for hours with the pet mind toy 100. It is an object of the present disclosure that the pet may be rewarded with a treat after completion of each activity. It is also an object of the present disclosure that each activity provided by the apparatus is designed for pets to enjoy while achieving a goal in accordance with each activity. In another embodiment, one or more pets may be engaged to perform an activity or solve a puzzle with a single pet mind toy 100.

The pet mind toy 100 may comprise the plurality of sides 102 connected together via the plurality of edges 104 of the plurality of sides 102. The plurality of sides 102 may be a first side 102a, a second side 102b, a third side 102c, a fourth side 102d, and a fifth side 102e. In one embodiment, each side 102a-102e may be interchangeable with separate sides or panels having different mind stimulating activities for pets. The pet mind toy 100 may be configured as a cubical box with each side provided for performing different activities for the pet. Further, the first side 102a of the plurality of sides 102 may comprise at least four slots carved into the first side 102a of the pet mind toy 100. Further, each slot may be provided with a space to place or hold a reward or treat for the pet. A first slot 106a and a second slot 106b may be a cubical box of pre-defined dimensions to hold the treat in place as shown in FIG. 1B. Further, each of the first slot 106a and the second slot 106b may be provided with a locking door 108 coupled at one end of each of the first slot 106a and the second slot 106b, and configured to be opened and closed using a fastening means 110, as shown in FIG. 1A and FIG. 1C. In one embodiment, the locking door 108 may be configured as a mesh of metallic rods welded together. In one exemplary embodiment, the first slot 106a and the second slot 106b may be 3.5 inches wide, 3.5 inches in height and 1-inch-deep within the first side 102a of the pet mind toy 100. Further, the first side 102a may comprise a third slot 112 and a fourth slot 114 carved into the first side 102a of the pet mind toy 100. The third slot 112 is described in conjunction with FIG. 1D, and the fourth slot 114 is described in conjunction with FIG. 1E.

Further, the fastening means 110 may comprise a lock 116, as shown in FIG. 1C, fixed to the first side 102a of the pet mind toy 100. Further, the lock 116 may be provided with a pair of holes for receiving a sliding rod 118, as shown in FIG. 1C. The mechanism of the fastening means 110 is that the sliding rod 118 may be configured to slide left and right into the lock 116, while opening and closing the locking door 108. In one embodiment, the locking door 108 may be made from a material selected from a group of materials of plastic, metal, wood, etc. In one exemplary embodiment, the locking door 108 is made of metallic rods welded together. In one embodiment, the thickness of the locking door 108 is 0.1 inches.

As shown in FIG. 1D, the first side 102a of the pet mind toy 100 may comprise the third slot 112 carved into the first side 102a generally below the slots 106a and 106b. In one embodiment, the third slot 112 may be a carved space into the pet mind toy 100 for placing the treat or reward for the pet. Further, the third slot 112 may be a cubical box with a pre-defined dimensions. In one embodiment, the third slot 112 may be a cube or pentagon. Further, the third slot 112 may be provided with a flap door 120 rotatably coupled at one side of the third slot 112 and kept free from the other side. In one embodiment, the flap door 120 may be provided for the pet to push open from other side and receive the treat or reward. It can be noted that the flap door 120 may be opened by the pet using its head when the treat or reward is received. In one embodiment, the flap door 120 may be made from a material selected from a group of materials comprising plastic, steel, wood, etc. In one exemplary embodiment, the flap door 120 is made from a hard plastic material with an enough thickness to retain the treat within the third slot 112 and to easily open when pushed or pulled by the pet to get the treat. In one embodiment, the third slot 112 may be of same dimensions as the first slot 106a and the second slot 106b. In one exemplary embodiment, the third slot 112 may be 3.5 inches wide, 3.5 inches high, and 1-inch-deep into the pet mind toy 100.

As shown in FIG. 1E and FIG. 1F of the pet mind toy 100, the toy 100 comprises a front view of the fourth slot 114. In one embodiment, the fourth slot 114 may be utilized for the same purpose as the first slot 106a, the second slot 106b, and the third slot 112. Further, the fourth slot 114 may be a space carved into the first side 102a of the pet mind toy 100 and may be integrated below the second slot 106b. In one embodiment, the fourth slot 114 may be the space to store a reward or treat for the pet. Further, the fourth slot 114 may be provided with a knob door 122 coupled rotatably at one side of the fourth slot 114. Further, the knob door 122 may be provided with a hole 124 integrated at one end of the knob door 122. In one embodiment, the hole 124 may be configured to receive a knob 126 for opening and closing the knob door 122. The knob door 122 may be configured to open and close the fourth slot 114 at other side using the knob 126. It is an object of the present disclosure that the knob 126 may act as a handle to open and close the fourth slot 114, as shown in FIG. 1G. In one embodiment, knob 126 may be rotated to open and close the knob door 122. In other embodiments, the dimensions of the fourth slot 114 may be the same as the third slot 112. In one exemplary embodiment, the knob door 122 may be 0.5 inches thick. In another exemplary embodiment, the hole 124 may be 0.5 inches in diameter. In another exemplary embodiment, the knob 126 may be a spherical shaped ball with a diameter of 1.5 inches.

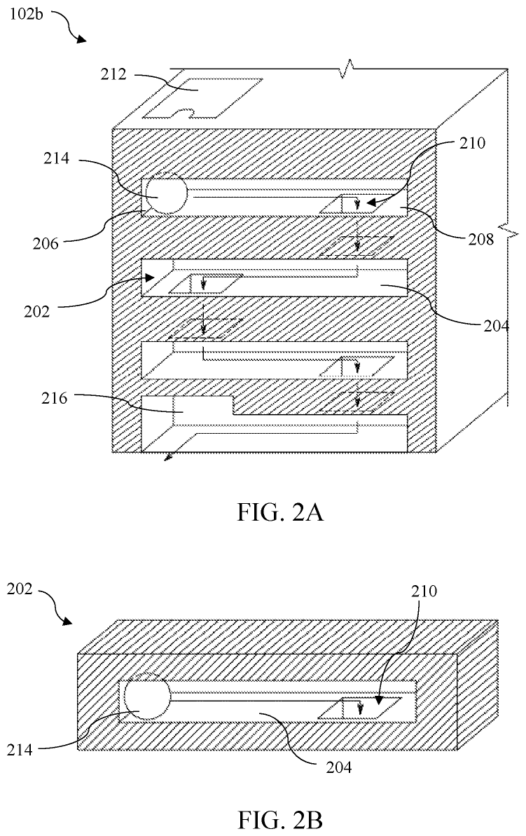

FIG. 2A illustrates a front view of the second side 102b of the pet mind toy 100, according to another embodiment of the present disclosure. FIG. 2A is explained in conjunction with FIGS. 1A-1F, FIG. 2B, FIG. 3, FIG. 4, and FIG. 5.

The second side 102b of the pet mind toy 100 may comprise a plurality of levels 202 carved into the second side 102b of the pet mind toy 100. Further, the plurality of levels 202 may enclose the plurality of slides 204 from top to bottom of the second side 102b of the pet mind toy 100. In one embodiment, the plurality of levels 202 may be rectangular shaped. Further, each slide 204 of the plurality of slides 204 may comprise a first end 206 and a second end 208. Further, the first end 206 and the second end 208 of each slide of the plurality of slides 204 may be provided with an opening 210, in an alternating fashion, as shown in FIG. 2A. It is an object of the present disclosure that the opening 210 integrated on each slide 204 may be an entry to a next slide 204 below a slide 204 and so on. Further, the second side 102b of the pet mind toy 100 may comprise a flap opening 212 disposed at top of the plurality of levels 202. In one embodiment, the flap opening 212 may be provided to place a ball 214 into the first slide 204. In one embodiment, each level 202 may be carved into the second side 102b in a manner that each slide 204 covers a small portion of the ball 214, so that the ball 214 does not fall out of the plurality of slides 204. Further, the second side 102b of the pet mind toy 100 may comprise an outer opening 216 integrated towards the first end 206 of a slide at the bottom of the second side 102b. In one embodiment, the ball 214 may be a tennis ball, fur ball, play ball, and the like which can rotate and slide over each slide 204.

For example, the second side 102b of the pet mind toy 100 includes four levels 202 with three slides 204 and three openings 210, and the ball 214 is placed from the flap opening 212 at the top of the second side 102b. The ball 214 moves into a top or first slide of the three slides 204, and the pet drags the ball 214 towards the opening 210 with its mouth or paws/legs, and as soon as the ball 214 reaches a first opening 210, it falls into a second slide 204 at a second level 202 downwards. Similarly, the pet drags the ball 214 to a third slide 204 at a third level 202 and then into a fourth level or a bottom level 202 of the second side 102b. Further, the pet may drag the ball 214 towards the outer opening 216 and therefore gets the ball 214. In one embodiment, as soon as the pet gets the ball 214, the pet moves the ball 214 towards the slot 210 to get the ball 214 out of the plurality of slides 204.

In one exemplary embodiment, the second side 102b of the pet mind toy 100 may be 16 inches high and 16 inches wide. In one embodiment, the second side 102b may comprise at least four levels 202 and at least three slides 204 with at least three openings 210. In one exemplary embodiment, each level 202 may be a rectangular section or rectangular window with length 12 inches and height of 2 inches, and each slide 204 may be 12 inches in length. In another exemplary embodiment, the flap opening 212 may be a square shaped slot with a flap cover. It can be noted that dimensions of the flap opening 212 may be more than the dimensions of the ball 214. In one embodiment, the flap opening 212 may be 3 inches wide and 3 inches long. Further, the outer opening 216 integrated at the bottom level 202 of the second side 102b may have height equal to more than the diameter of the ball 214. In one exemplary embodiment, the height of the outer opening 216 may be 3 inches.

FIG. 2B illustrates a sectional view of the slide 204 of the second side 102b of the pet mind toy 100, according to another embodiment of the present disclosure. FIG. 2B is explained in conjunction with FIGS. 1A-1F, FIG. 2A, FIG. 3, FIG. 4, and FIG. 5. Further, each slide 204 of the plurality of slides 204 may be stacked at an inclination from the first end 208 to the second end 206 of each slide. In one embodiment, the first end 208 may be placed slightly higher than the second end 206 of each slide 204, so that the pet must drag the ball 214 towards the opening 210. In one exemplary embodiment, the inclination of each slide of the plurality of slides 204 may be at least 5 degrees with respect to each level of the plurality of levels 202.

Further, each level of the plurality of levels 202 may be a rectangular box of pre-defined dimensions. Further, each rectangular box may have a front opening for the pet to slide down the ball 214 towards the opening 210 at the second end 208 of the plurality of slides 204. It is an object of the present disclosure that the height of the front opening may be less than the total height of each rectangular box. In one embodiment, each level of the plurality of levels may be 3 inches deep carved into the second side 102b of the pet mind toy 100. In one exemplary embodiment, each level 202 may have a total height of 3 inches with front opening of 2 inches so that the ball 214 does not completely swing out of each level. In another exemplary embodiment, if the ball 214 has a diameter of 3 inches, then only about 1-1.5 inches of the ball 214 may be visible from each level for the pet to push down the ball 214 towards the opening 210. It is an object of the present disclosure that the opening 210 at each slide of the plurality slides 204 may have dimensions equal to less than the dimensions of the flap opening 212 at the top of the second side 102b. In one exemplary embodiment, the opening 210 is a 3 inches square shaped cut to connect with the next level.

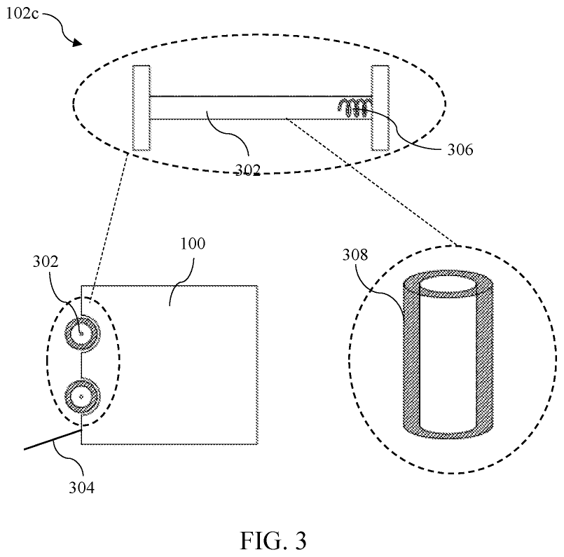

FIG. 3 illustrates the third side 102c of the plurality of sides 102 of the pet mind toy 100, according to an embodiment of the present disclosure. FIG. 3 is described in conjunction with FIGS. 1A-1F, FIGS. 2A-2B, FIG. 4, and FIG. 5. The third side 102c of the plurality of sides 102 may comprise a rod 302, a tray 304, a spring 306, and a silicon holder 308. In one embodiment, the silicon holder may be referred to as a popsicle. The rod 302 may be coupled to the third side 102c of the pet mind toy 100. Further, the rod 302 may be configured to receive the silicon holder 308 and may be locked into the third side 102c of the pet mind toy 100. Further, the third side 102c may comprise the tray 304 to catch ice from the silicon holder 308 placed on the rod 302. In one embodiment, the tray 304 may be made from a material selected from a group of materials of plastic, steel, wood, etc. In one exemplary embodiment, the tray 304 is made from plastic. It is an object of the present disclosure that the rod 302 may be provided with the spring 306 to keep the silicon holder 308 in place. Further, the third side 102c of the pet mind toy 100 may comprise the silicon holder 308 coupled with the rod 302. In one embodiment, the silicon holder 308 may be a cylindrical structure with one end open. In one exemplary embodiment, the popsicle 308 may be 7 inches tall with an outer diameter of 2 inches and an inner diameter of 1-1.5 inches. In one embodiment, the silicon holder 308 may continuously melt down with respect to the surrounding temperature and the tray 304 may catch the melting ice from the silicon holder 308. In one embodiment, the silicon holder 308 and the rod 302 may be like a toilet paper holder, affixed to the third side 102c of the pet mind toy 100. In another embodiment, the tray 304 may be placed transversely at an inclination to the third side 102c of the pet mind toy 100. Further, the silicon holder 308 may be provided for the pet to quench thirst or serve as a treat while playing with the pet mind toy 100. It can be noted that each pet mind toy 100 may have different popsicles for different pets.

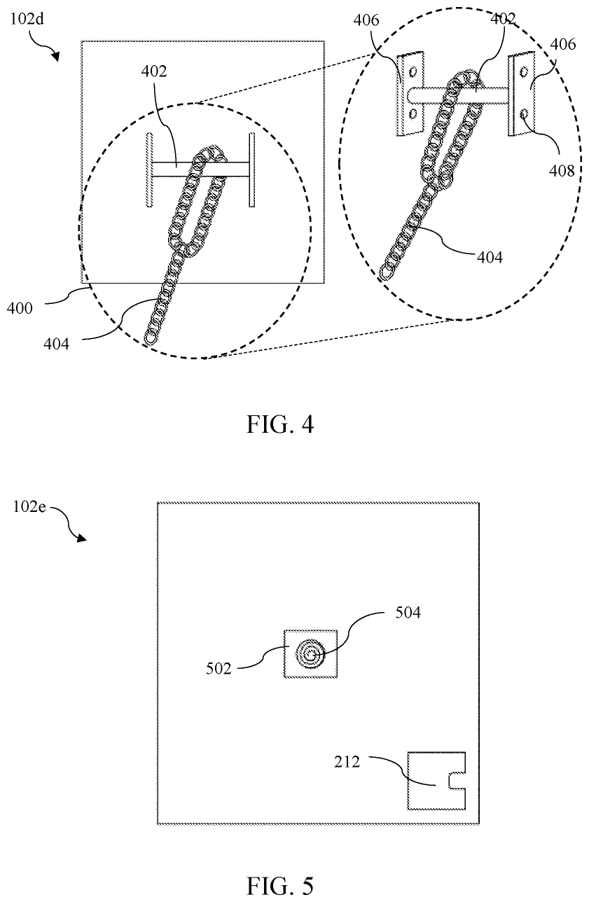

FIG. 4 illustrates a pull toy 400 coupled at a fourth side 102d of the plurality of sides of the pet mind toy 100, according to another embodiment of the present disclosure. FIG. 4 is explained in conjunction with FIGS. 1A-1F, FIGS. 2A-2B, FIG. 3, and FIG. 5. The pull toy 400 may be disposed or coupled at the fourth side 102d of the pet mind toy 100. Further, the pull toy 400 may comprise a handle 402 fastened to the fourth side 102d of the pet mind toy 100. Further, the pull toy 400 may comprise a braided rope 404 coupled at one end to the handle 402 and free at the other end of the braided rope 404. In one embodiment, the other end of the braided rope 404 may be provided for the pet to pull the pet mind toy 100. Further, the handle 402 may be attached to the fourth side 102d of the pet mind toy 100 using one or more coupling means such as a pair of straps 406. Further, each strap of the pair of straps 406 may be provided with a pair of holes 408 to receive screws (not shown) to affix the handle 402 with the fourth side 102d.

In another embodiment, the pull toy 400 may be provided so that the pet may play tug with it, bat at it, etc. In one embodiment, the pull toy 400 may be of different dimensions according to the shape and size of the pet. In one exemplary embodiment, the pull toy 400 may be 6 inches in height affixed at a height of about 7 inches from the bottom of the fourth side 102d. In another exemplary embodiment, the handle 402 may be 8 inches long with ends 1 inches thick. In another exemplary embodiment, the braided rope 404 may be 14 inches in length with a knot of 8 inches. Further, the handle 402 may be made from a material selected from a group of materials including wood, metal, plastic, etc. In one exemplary embodiment, the handle 402 is a metallic handle affixed to the fourth side 102d of the pet mind toy 100, with a gap of 2 inches between a central part of the handle 402 and the fourth side 102d, so that the braided rope 404 can be easily tied to the handle 402.

FIG. 5 illustrates a top view of a fifth side 102e of the pet mind toy 100, according to another embodiment of the present disclosure. FIG. 5 is explained in conjunction with FIGS. 1A-1F, FIGS. 2A-2B, FIG. 3, and FIG. 4. The fifth side 102e of the pet mind toy 100 may comprise means for adding weight such as one or more metal plates, dumb bells, etc. to the pet mind toy 100. In an embodiment, the pet mind toy 100 may comprise a liquid filling opening 502 integrated, for example, at a center of the fifth side 102e. Further, the liquid filling opening 502 may comprise a screw-top 504 embedded into the liquid filling opening 502. In one embodiment, the liquid filling opening 502 may be provided to fill water into the pet mind toy 100 so that the pet may play tug with it. In one embodiment, the liquid filling opening 502 may be integrated into the fifth side 102e of the pet mind toy 100 and the screw-top 504 may be embedded normal into the liquid filling opening 502 towards an end of the liquid filling opening 502, to prevent the pet from pulling or biting. In one embodiment, the liquid filling opening 502 may be a square shaped box carved into the fifth side 102e of the pet mind toy 100. It is an object of the present disclosure that the dimensions of the liquid filling opening 502 may depend upon the shape and size of the pet. In one exemplary embodiment, the liquid filling opening 502 may be a 2 inches square with 1 inch in depth. In another embodiment, the liquid filling opening 502 may be provided to receive water into the pet mind toy 100 so that the pet can play tug with it. In one exemplary embodiment, the weight of the pet mind toy 100 along with the filled-in water is 40 pounds. In one exemplary embodiment, different weights can be made for use with different breeds, sizes, weights, etc. of pets, such as cat or dog, respectively.

In one alternate embodiment, the purpose of the pet mind toy 100 may be to keep the pet happily occupied for a longer extended period of time. Further, different mind stimulating tasks may be played using the above mentioned pet mind toy 100. In one embodiment, the pet mind toy 100 is modular and each side can be assembled and disassembled depending upon the requirements of the pet owner. Further, each side of the pet mind toy 100 is interchangeable with other separate panels or sides. In one embodiment, the multi-activity toy or herein referred as pet mind toy 100 may be of any geometric shape such as a cube, pentagon, pyramid shape, rectangular, and the like.

It will be apparent to one skilled in the art that the above-mentioned components of the pet mind toy 100 have been provided only for illustration purposes. Further, embodiments of the present invention relate to an article of pet mind toy 100 that, upon installation turns into multi-activity mind stimulating toy for pets, without departing from the scope of the disclosure.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A pet mind toy comprising:
a plurality of sides detachably coupled to each other via a plurality of edges, wherein a first side of the plurality of sides comprises:
at least four slots carved into the first side for holding treats for a pet; and
at least four doors for the least four slots;
a second side of the plurality of sides comprise:
a plurality of levels with each level having a slide inclined with respect to each level from a first end towards a second end;
a plurality of openings integrated at the second end of each slide to connect the plurality of levels; and
a flap opening integrated over the second side to receive a ball into the plurality of levels, wherein the ball moves between the plurality of levels through the plurality of openings;
a third side of the plurality of sides having a rod coupled with a popsicle placed in a tray; and
a fourth side of the plurality of sides having a pull toy affixed to the fourth side for the pet to play tug with the pull toy, wherein the plurality of sides engages the pet in mind stimulating activities for a time duration without intervention.

2. The pet mind toy of claim 1, further comprising a fifth side with a means for adding weight to the pet mind toy.

3. The pet mind toy of claim 1, further comprising a fifth side with a liquid-filling opening for filling a liquid to impart weight to the pet mind toy, for using the pet mind toy to tug.

4. The pet mind toy of claim 1, wherein each level of the plurality of levels expose only about 1″-1.5″ of ball for the pet to push the ball down towards each opening of each slide.

5. The pet mind toy of claim 1, wherein the pet mind toy includes a plurality of sides, wherein at least one of the plurality of sides is fashioned as a geometric shape having at least three edges.

6. The pet mind toy of claim 1, wherein the pet mind toy is at least a cube, a pentagon, a pyramid, or a rectangular shaped toy.

7. The pet mind toy of claim 1, wherein at least two doors from the at least four doors with carved out slots, are locking doors.

8. The pet mind toy of claim 1, wherein at least one door from the at least four doors with carved out slots, is a flap door.

9. The pet mind toy of claim 1, wherein at least one door from the at least four doors with carved out slots, having a knob.

10. The pet mind toy of claim 1, wherein the ball placed on the second side may be moved from the first end of each slide to the second end towards each opening of each slide.

11. The pet mind toy of claim 8, wherein the ball placed on the second side comes out of the pet mind toy via an outer opening integrated at one level of the plurality of levels.

12. The pet mind toy of claim 1, wherein the tray is a thin plastic tray used to catch melting ice from the popsicle.

13. The pet mind toy of claim 1, wherein the popsicle is 7″ tall, 2″ wide, 0.5″ thick, and 1″ hollow.

14. The pet mind toy of claim 1, wherein the plurality of sides of the pet mind toy are modular and interchangeable.

15. A pet mind toy comprising:
a plurality of sides detachably coupled to each other via a plurality of edges, wherein a first side of the plurality of sides comprises:
at least four slots carved into the first side for holding treats for a pet; and
at least four doors for the least four slots;
a second side of the plurality of sides comprise:
a plurality of levels with each level having a slide inclined with respect to each level from a first end towards a second end;
a plurality of openings integrated at the second end of each slide to connect the plurality of levels; and
a flap opening integrated over the second side to receive a ball into the plurality of levels which moves between the plurality of levels via the plurality of openings;
a third side of the plurality of sides comprises:
a rod holding a popsicle placed in a tray, wherein the rod is provided with a means for securing the popsicle, wherein the tray is configured to collect melting ice from the popsicle placed over the rod to minimize mess around the pet mind toy; and
a fourth side of the plurality of sides comprises a pull toy affixed to the fourth side for the pet to play tug with the pull toy, wherein the plurality of sides engages the pet in mind stimulating activities for longer duration without intervention.

16. The pet mind toy of claim 13, wherein the pull toy comprises
a handle coupled to the fourth side of the pet mind toy using a pair of straps; and
a braided rope knotted to the handle for the pet to play tug with the pull toy.

17. The pet mind toy of claim 13, further comprising a fifth side with a liquid filling opening for filling a liquid to impart weight to the pet mind toy, for using the pet mind toy to tug.

18. The pet mind toy of claim 15 wherein the rod is provided with a spring to push the popsicle.
